(19) United States
(12) Patent Application Publication
(10) Pub. No.: US 2023/0287280 A1
(43) Pub. Date: Sep. 14, 2023

(54) PROCESS FOR HYDROTREATMENT OF MATERIALS FROM RENEWABLE SOURCES

(71) Applicant: SHELL OlL COMPANY, Houston, TX (US)

(72) Inventors: Nicolaas VAN DIJK, Amsterdam (NL); Andries Hendrik JANSSEN, Amsterdam (NL); Gerald Max LAWRENCE, Houston, TX (US); Roy Léon Bernard HENKET, Amsterdam (NL); Julien SIGAUD, Amsterdam (NL)

(21) Appl. No.: 18/005,869

(22) PCT Filed: Aug. 20, 2021
(86) PCT No.: PCT/EP2021/073144

§ 371 Date: Jan. 18, 2023

(30) Foreign Application Priority Data
Aug. 21, 2020 (EP) 20192161.6

(51) Int. Cl. C10G 45/08; B01J 8/04

(52) U.S. Cl. CPC C10G 45/08; B01J 8/0492; B01J 8/0446; C10G 2300/1018; B01J 2208/00938; B01J 2208/00902

(57) ABSTRACT

A process for hydroprocessing a renewable feedstock involves introducing the renewable feedstock and hydrogen in a downward flow into a top portion of a fixed-bed reactor and distributing the downward flow to a top surface of a first catalyst bed in a manner such that the top surface is uniformly wetted across the reactor cross section. The feedstock then flows downwardly through the first catalyst bed, where it is reacted under hydroprocessing conditions sufficient to cause a reaction selected from the group consisting of hydrogenation, hydrodeoxygenation, hydrodenitrogenation, hydrodesulphurization, hydrodemetallization, hydrocracking, hydroisomerization, and combinations thereof. A hydrocarbon liquid separated from the reaction effluent is recycled to the renewable feedstock in a ratio of 0.4:1 to 1.8:1, based on the volume of the renewable feedstock.

### FIELD OF THE INVENTION

The present invention relates to a process for the hydrotreatment of a feedstock comprising materials from renewable sources, useful for the production of fuels, fuel components and/or chemical feedstocks.

### BACKGROUND OF THE INVENTION

The increased demand for energy resulting from worldwide economic growth and development have contributed to an increase in concentration of greenhouse gases in the atmosphere. This has been regarded as one of the most important challenges facing mankind in the 21st century. To mitigate the effects of greenhouse gases, efforts have been made to reduce the global carbon footprint. The capacity of the earth's system to absorb greenhouse gas emissions is already exhausted. Accordingly, there is a target to reach net-zero emissions by 2050. To realize these reductions, the world is transitioning away from solely conventional carbon-based fossil fuel energy carriers. A timely implementation of the energy transition requires multiple approaches in parallel, including for example, energy conservation, improvements in energy efficiency, electrification, and efforts to use renewable resources for the production of fuels and fuel components and/or chemical feedstocks.

Vegetable oils, oils obtained from algae, and animal fats are seen as renewable resources. Also, deconstructed materials, such as pyrolyzed recyclable materials or wood, are seen as potential resources.

Renewable materials may comprise materials such as triglycerides with very high molecular mass and high viscosity, which means that using them directly or as a mixture in fuel bases is problematic for modern engines. On the other hand, the hydrocarbon chains that constitute, for example, triglycerides are essentially linear and their length (in terms of number of carbon atoms) is compatible with the hydrocarbons used in/as fuels. Thus, it is attractive to transform triglyceride comprising feeds in order to obtain good quality fuel components. As well, renewable feedstocks may comprise unsaturated compounds and/or oxygenates that are unsaturated compounds.

The renewable feedstocks, whether processed alone or coprocessed with petroleum-derived feedstocks, are therefore hydrotreated to remove contaminants such as, but not limited to, oxygen, sulphur, and nitrogen.

Examples of such processes are available. For example, Craig et al. (U.S. Pat. No. 4,992,605, 12 Feb. 1991) disclose a process for producing hydrocarbon products in the diesel boiling range, mainly C15-C18 straight chain paraffins, the process comprising hydroprocessing vegetable oils or some fatty acids at conditions effective to cause hydrogenation, hydrotreating and hydrocracking of the feedstock (temperature 350-450° C.; pressure 4.8-15.2 MPa; liquid hourly space velocity 0.5-5.0 hr-1) using a commercially available hydroprocessing catalyst. Cobalt-molybdenum and nickel-molybdenum hydroprocessing catalysts are mentioned as suitable catalysts.

Monnier et al. (U.S. Pat. No. 5,705,722, 6 Jan. 1998) relates to a process for producing liquid hydrocarbons boiling in the diesel fuel range from a biomass feedstock comprising tall oil with a relatively high content of unsaturated compounds. The feedstock is hydroprocessed at a temperature of at least 350° C.

More recently, there has been an appreciation that hydrogenation of unsaturated compounds, such as olefins, diolefins, and aromatics, is highly exothermic. Hydrodeoxygenation is also an exothermic reaction. Renewable feedstocks with a high content of unsaturated compounds will generate a significant heat release upon complete hydrogenation of all unsaturated compounds. The high exothermicity will result in a large temperature increase over the catalyst beds in the reactor, if no measures are taken.

Currently, the high exothermicity in hydroprocessing of renewable materials is generally dealt with by application of a high liquid recycle rate to the reactor inlet in combination with a significant amount of liquid quench. The recycle and/or quench streams are used to dilute the reactivity of the fresh feed and provide a heat sink for the exothermic reaction.

For example, Myllyoja et al. (U.S. Pat. No. 8,859,832B2, 14 Oct. 2014) describes a process for the manufacture of diesel range hydrocarbons wherein a feed is hydrotreated in a hydrotreating step and isomerized in an isomerization step. The feed, comprising fresh feed containing more than 5 wt. % of free fatty acids and at least one diluting agent, is hydrotreated at a reaction temperature of 200-400° C., in a hydrotreating reactor in the presence of catalyst, and the ratio of the diluting agent/fresh feed is 5-30:1. The diluting agent is needed, according to Myllyoja et al., to reduce undesired side reactions, improve reaction selectivity, limit temperature increases in the catalysts beds, avoid harmful and partially converted intermediate products, and extend catalyst life considerably.

As another example, Marker et al. (U.S. Pat. No. 7,982,076B2, 19 Jul. 2011), describes a process for producing diesel boiling range fuel from renewable feedstocks such as plant oils, animal fats and oils, and greases which involves treating a renewable feedstock by hydrogenating and deoxygenating to provide a diesel boiling range fuel hydrocarbon product. In the process of Marker et al., a portion of the hydrocarbon product is recycled to the treatment zone to increase the hydrogen solubility of the reaction mixture. The volume ratio of recycle to feedstock is in the range of about 2:1 to about 8:1. Simulations show that the hydrogen solubility increases rapidly until a recycle ratio of 2:1. From recycle to feed ratios of 2:1 to 6:1, the simulation showed that hydrogen solubility remained high. According to Marker et al., one benefit of the hydrocarbon recycle is to control the temperature rise across the individual beds. Reportedly, without recycling, after some time, the level of oxygen in the product started to continuously increase indicating the catalyst had significantly deactivated and triglycerides were no longer sufficiently reacted.

However, using product for recycle and/or quench adds to the total hydraulic load of the system, to the energy consumption and to increased size of equipment. Further, it should be noted that if gas would be used as quench, the amount of gas that would be required to quench the exothermicity would be very large. Generally, these conventional solutions adversely affect the cost effectiveness and energy efficiency of the operation.

Toppinen et al. (WO2020/165496A1, 20 Aug. 2020) describes a fluid mixer having a cylindrical mixing chamber, a first fluid inlet for conducting effluent from the first catalyst bed to the mixing chamber to produce a spiral stream in the mixing chamber and a second fluid inlet for conducting a quench fluid tangentially into the spiral stream. An outlet channel is concentric to the mixing chamber and directs mixed fluids downward at a central location. The outlet channel is used to produce turbulence in the stream of bed effluent and quench fluids to reduce local concentration maxima in the mixture, thereby reducing corrosion risk of material surfaces that are in contact with the mixture of the fluids coming out from the fluid mixer.

Himelfarb et al. (US2008/0004476A1, 3 Jan. 2008) discloses a process for hydrogenation of aromatics in a hydrocarbon feedstock containing a thiopheneic compound. A fluid distribution means including a horizontal tray with a plurality of openings for the downflow of the feedstock onto the top surface area of the nickel-based catalyst bed. The fluid distribution means reduces hot spots and hot regions within the catalyst bed resulting in a higher conversion of the thiopheneic compound. Optionally, a portion of the liquid phase product may be recycled to provide an improved overall aromatics conversion and/or to control start-of-run temperature.

Chapus et al. (US2012/0059209A1, 8 Mar. 2012) recognizes problems associated with high recycle ratios, including high pressure drop, high linear velocity, high hydraulic load, and larger reactor volume. To address the problem, Chapus et al. divided the raw material stream into a number of different partial stream F1 to Fn identical to the number of catalyst beds n in the reactor system. A stream of hydrogen is also divided into the same number of partial streams H1 to Hn. When n is greater than 2, each partial stream of raw material feed is much larger than the preceding one. Temperature at the reactor inlet at the first catalyst bed is adjusted by adding diluting agent only to the streams F1 and H1. A challenge with this solution is that controlling exothermicity is more complicated with a divided feed, while catalyst is underutilized with feed bypassing catalyst beds.

There remains a need for improving the cost effectiveness and energy efficiency of hydroprocessing processes, preferably with improved yields. Specifically, there remains a need to avoid the operating and capital costs associated with recycling high volumes of reaction product, while addressing the problem of a highly exothermic reaction of renewable feedstocks.

### SUMMARY OF THE INVENTION

According to one aspect of the present invention, there is provided a process for hydroprocessing a renewable feedstock comprising the steps of introducing the renewable feedstock and hydrogen in a downward flow into a top portion of a fixed-bed reactor; distributing the downward flow to a top surface of a first catalyst bed in a manner such that the top surface is uniformly wetted across the reactor cross section; allowing the renewable feedstock to flow downwardly through the first catalyst bed; reacting the renewable feedstock in the catalyst bed under hydroprocessing conditions sufficient to cause a reaction selected from the group consisting of hydrogenation, hydrodeoxygenation, hydrodenitrogenation, hydrodesulphurization, hydrodemetallization, hydrocracking, hydroisomerization, and combinations thereof to produce a hydrocarbon effluent; separating a hydrocarbon liquid stream from the hydrocarbon effluent; and recycling the hydrocarbon liquid for the renewable feedstock in a ratio of 0.4:1 to 1.8:1, based on the volume of the renewable feedstock.

### BRIEF DESCRIPTION OF THE DRAWING

The process of the present invention will be better understood by referring to the following detailed description of preferred embodiments and the drawings referenced therein, in which:

FIGS. 1A-1E are schematic simulations of prior art distribution of downward flow;

FIGS. 2A-2E are schematic simulations of distribution of downward flow in accordance with one embodiment of the present invention; and

FIG. 3 is a schematic representation of one embodiment of a reactor for use in the process according to the invention.

### DETAILED DESCRIPTION OF THE INVENTION

The present invention provides a process for hydroprocessing a renewable feedstock in a fixed-bed reactor. In accordance with the present invention, capital and operating costs can be reduced for a given product yield. Reduced operating costs translates to improved energy efficiency and a lower carbon footprint. Furthermore, the process of the present invention has improved flexibility for managing a wider range of renewable feedstocks that have different saturation levels and/or different oxygen levels, which, in turn, have wide variation in reaction exothermicity.

In accordance with the present invention, the need for recycle can be reduced compared to conventional techniques. According to the present invention, recycle is in a range of 0.4 to 1.8 times the fresh feed on a volume basis. By providing a process scheme capable of operating over the range of 0.4:1 to 1.8:1 recycle, the process has the flexibility to adapt to changes in renewable feedstock due to supply, markets, season, quality, and the like. For example, a soybean oil feedstock generally has a considerably higher degree of unsaturation than a palm oil feedstock. The resulting spread in exothermicity can result in needing, for example, two times the amount of recycle for one feed compared to another. Having a process that is capable of operating in a recycle range of 0.4 to 1.8 times the feed provides flexibility when changes in feedstock are required.

While the examples presented herein demonstrate that unexpectedly good results were also shown for 0 recycle, the recycle ratio for the process of the present invention is in the range of 0.4 to 1.8 times the fresh feed on a volume basis to provide flexibility due to changes in feedstock variability. Without recycle, adjustments would be provided by adding more catalyst beds for a highly unsaturated renewable feedstock or removing catalyst beds for a highly saturated renewable feedstock. This solution is, however, not very flexible or practical because the modifications would require significant down-time and a significant loss in production.

Contrary to conventional wisdom of large recycle ratios and divided feed streams, the process of the present invention addresses the problem of highly exothermic reactions by uniformly wetting a top surface of the catalyst beds in a fixed bed reactor.

By “uniformly wetted,” we mean that at least 90%, preferably 95%, most preferably 100%, of the top surface of the catalyst bed is contacted by the downflow at a liquid velocity having a distribution range between highest and lowest local liquid velocities of at most 10%. Measuring liquid velocities is commonly known in the art.

Uniform wetting of the catalyst surface reduces the occurrence of localized hot spots. This improves process efficiency, reduces reactor and catalyst costs, and improves safety. The process of the present invention is important for the energy transition and can improve the environment by producing low carbon energy and/or chemicals from renewable sources, and, in particular, from degradable waste sources, whilst improving energy efficiency of the process. By uniform wetting, the catalyst beds can be operated at a higher ΔT and also the ΔT over the reactor will be higher, thereby reducing the volume of recycle and, optionally, quench and recycle needed, as compared to conventional processes.

For a given feedstock, throughput and desired reaction severity, as compared to a conventional process, the present invention allows for reduced operating temperature, reduced WABT (weighted average bed temperature), and/or increased LHSV (liquid hourly space velocity) to reach the same conversion.

Improved wetting may be accomplished by a modification to a conventional distribution tray by increasing the density of the nozzles, in the distribution tray, changing the downward flow pattern from the nozzles, and combinations thereof.

In a preferred embodiment, a downward flow of renewable feedstock is directed to a distribution tray having a plurality of nozzles. The downward flow of liquid and gas is distributed through the plurality of nozzles to a catalyst bed in a manner such that the area contacted by the downward flow from each of the plurality of nozzles overlaps the area contacted by the downward flow from at least another of the plurality of nozzles. In this way, a top surface of the catalyst bed is uniformly wetted across the reactor cross section.

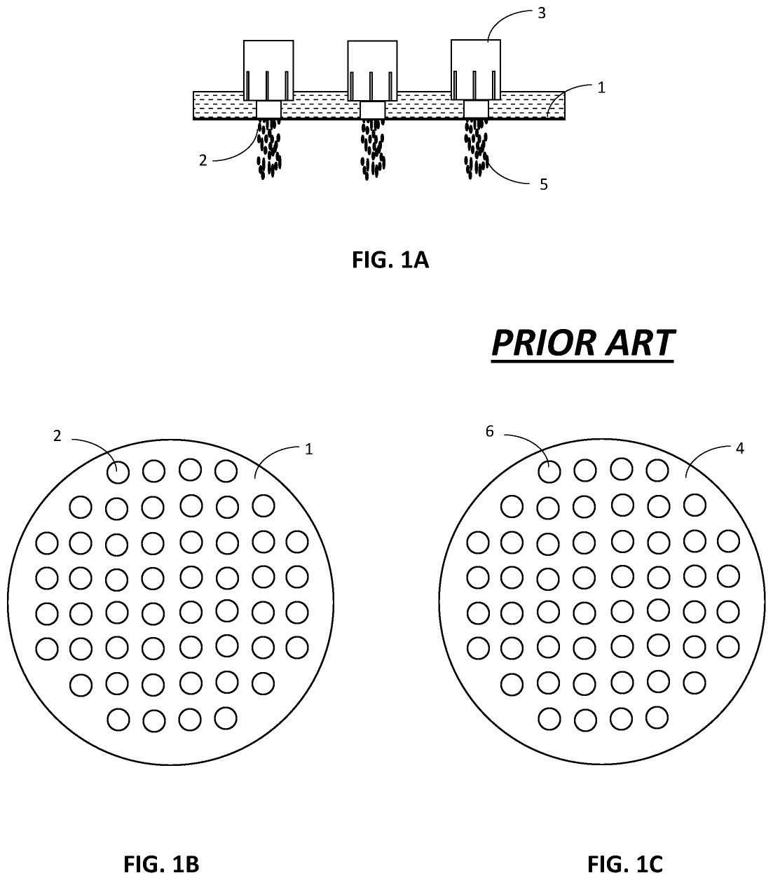

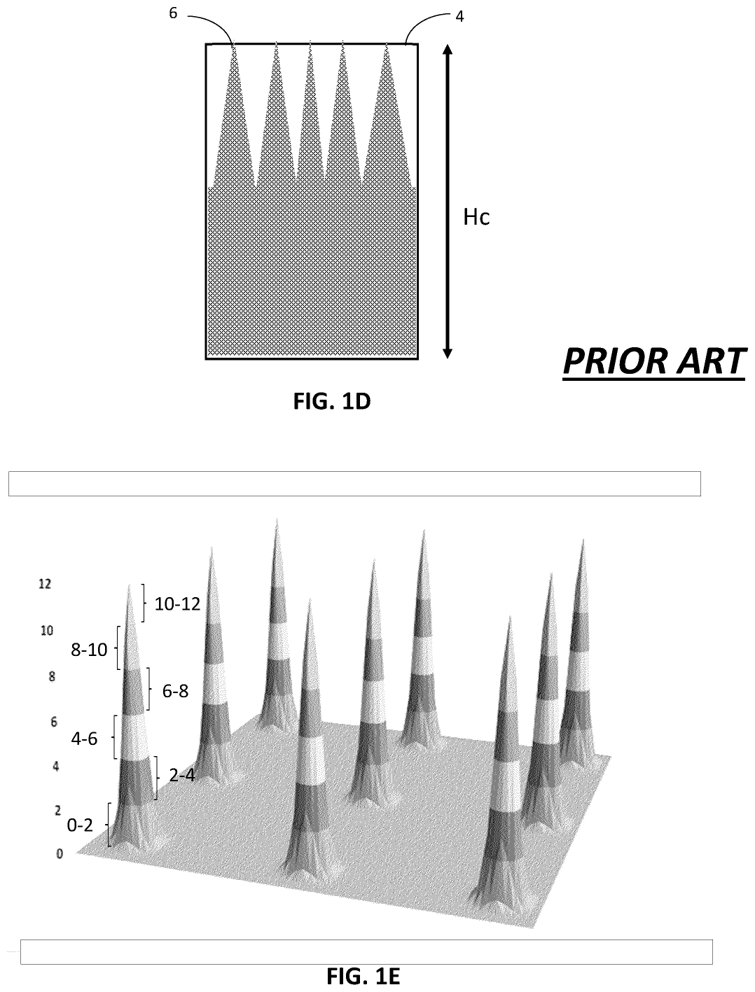

The advantages of the present invention over conventional processes are illustrated by first reviewing FIGS. 1A-1E. In one embodiment of a conventional process, downward flow is directed to a vapor/liquid distribution tray 1 having a plurality of holes 2 across the cross-section of the tray 1. The distribution tray 1 is typically a chimney type or a bubble cap type distribution tray to distribute liquid entering the reactor via its inlet pipe or device, on top of the catalyst bed below.

In FIG. 1A, the distribution tray 1 has a bubble cap 3 associated with each opening 2 in the distribution tray 1. FIG. 1B is a depiction of a pattern of openings 2 in a distribution tray 1 that has been simplified for ease of illustration to show a smaller number of openings 2 with a larger relative diameter compared to the tray diameter. It will be understood by those skilled in the art that a conventional distribution tray will have a larger number of openings 2, and each will have a smaller diameter relative to the tray diameter. Instead of the bubble cap 3, the distribution tray may be provided with nozzles, other bubble caps, or other type of opening in the tray.

The liquid flows downwardly through the bubble caps 3 to a top surface 4 of the catalyst bed. The downflow 5 from each nozzle wets the top surface 4 in a pattern, simulated in FIG. 1C, that is most likely a mirror-image of the pattern of the tray openings 2. The wetted area 6 is substantially the same as the cross-sectional area of the combined openings. It will be understood that a portion of the top surface of the catalyst bed may become wet by reactor humidity, splashing, or misting of the downward flow. However, this type of wetting tends to be superficial, not having the pressure to wet the complete catalyst volume below, and is, therefore, outside the definition of uniform wetting of the present invention.

By wetting the top surface of the catalyst bed in a limited pattern, a significant portion of the top surface, and subsequently the volume of catalyst below, is not wetted by the downflow. For example, distribution trays with conventional chimneys wet about 15% of the top surface of the catalyst bed, while distribution trays with conventional bubble caps wet about 30% of the top surface of the catalyst bed. FIG. 1D illustrates the consequential maldistribution of the downflow through the catalyst bed from the wetted area 6 at the top surface 4 of the catalyst bed. In this depiction, the catalyst is nonuniformly wetted through approximately 50% of the height Hc of the catalyst bed. The liquid velocity of the downflow through the catalyst bed was calculated and the results are presented in the simulation in FIG. 1E. The peaks in FIG. 1E show that the liquid velocity at the top surface of the catalyst bed to be in a range of 10-12. Thereafter, the liquid velocity slows as distribution gradually increases through the catalyst bed.

FIGS. 1D and 1E illustrate that, in conventional processes, dispersion of the feedstock is slow and ineffective. This can lead to underutilized catalyst and/or bed-grading material, thermal maldistribution, poor performance, shorter catalyst cycle length, higher energy consumption and/or localized hot spots.

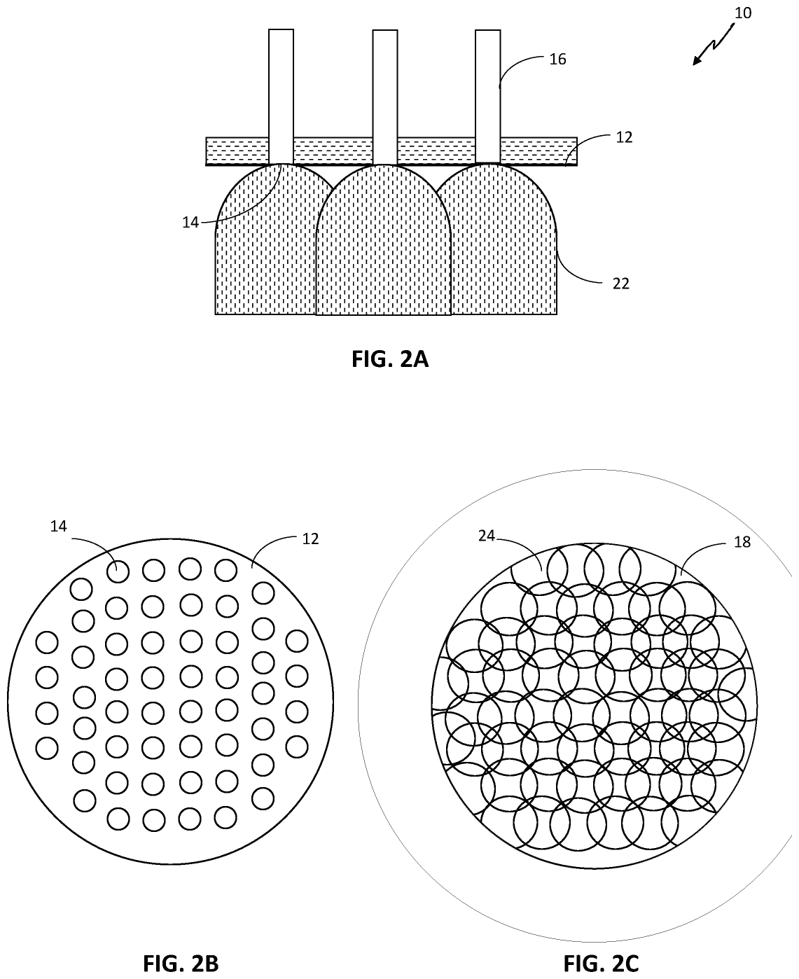

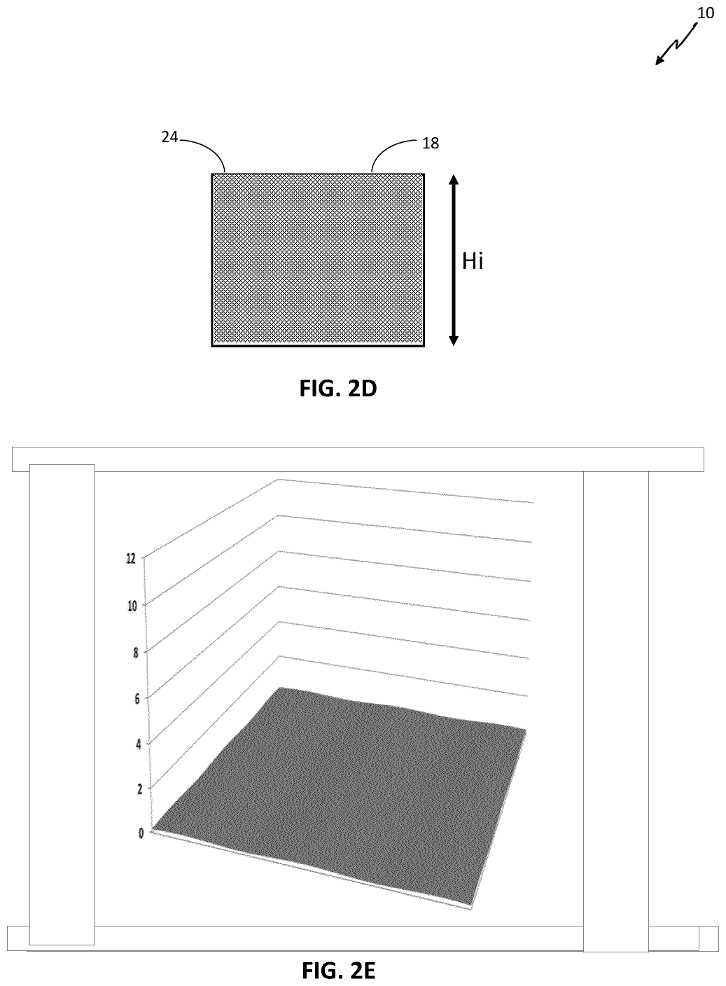

FIGS. 2A-2E illustrate advantages of the process of the present invention 10 in comparison to Prior Art FIGS. 1A-1E.

In FIG. 2A, a distribution tray 12 has openings 14 to allow for flow of fluid. The fluid includes the renewable feedstock and hydrogen. The fluid will also include recycled hydrocarbon liquid from the reaction product. Optionally, the fluid also comprises any petroleum-derived hydrocarbons when coprocessing. FIG. 2B is a depiction of a pattern of openings 14 in the distribution tray 12. The distribution tray 12 is provided with nozzles 16 at the openings 14 in the tray 12.

The fluid flows downwardly through the nozzles 16 to a top surface 18 of the catalyst bed. The downflow 22 from each nozzle 16 wets the top surface 18 in a pattern, simulated in FIG. 2C, that is an enlarged image of the pattern of the tray openings 14. The wetted area 24 is significantly larger than the cross-sectional area of the combined openings 14. The top surface 18 of the catalyst is therefore uniformly wetted.

By uniformly wetting the top surface 18 of the catalyst bed, problems associated with maldistribution, as depicted in FIGS. 1A-1E are avoided. FIG. 2D illustrates the consequential improvement of the downflow through the catalyst bed from the wetted area 24 at the top surface 18 of the catalyst bed. By uniformly wetting the top surface 18 of the catalyst bed, the catalyst is uniformly wetted throughout the bed. In a comparison of FIGS. 1D and 2D, it can be seen that the fully wetted portion of the catalyst bed in accordance with the present invention 10, Hi, is approximately 100% of the height of the catalyst bed whilst it equals about 50% of Hc in the prior art depicted in FIG. 1D.

The fluid velocity of the downflow through the catalyst bed was calculated and the results are presented in the simulation in FIG. 2E. By comparing the results for conventional processes in FIG. 1E, it can be seen from the simulation in FIG. 2E that the fluid velocity for the process of the present invention is substantially uniform at a velocity in a range of 0.1-0.3, with 100% wetting of the top surface, compared to conventional technologies that wet approximately 5% of the surface with a difference between maximum and minimum of 0-11.

Comparing FIGS. 2D and 2E with FIGS. 1D and 1E, respectively, shows the impact of uniformly wetting the top surface of the catalyst bed in accordance with the process of the present invention. The present invention allows for better dispersion of the feedstock to improve contact with catalyst and/or bed-grading material, improved thermal distribution, improved performance, reduced energy consumption, longer catalysts cycle length, and/or reduction in localized hot spots.

An example of a commercially available distribution tray useful for an embodiment of the invention is a high-dispersion distributor tray available from Shell Catalysts and Technologies. Müller (U.S. Pat. No. 7,506,861, 24 Mar. 2009) has a perforated plate at the base of a nozzle, while Koros et al. (U.S. Pat. No. 5,403,561, 4 Apr. 1995) illustrates a spray generating device. Modifications like these, in a sufficient density, when appreciating the importance of uniformly wetting to produce downflow at a liquid velocity having a distribution range between highest and lowest local liquid velocities of at most 10%, may be used in the present invention.

As used herein, the terms “renewable feedstock”, “renewable feed”, and “material from renewable sources” mean a feedstock from a renewable source. A renewable source may be animal, vegetable, microbial, and/or bio-derived or mineral-derived waste materials suitable for the production of fuels, fuel components and/or chemical feedstocks.

A preferred class of renewable materials are bio-renewable fats and oils comprising triglycerides, diglycerides, monoglycerides and free fatty acids or fatty acid esters derived from bio-renewable fats and oils. Examples of such fatty acid esters include, but are not limited to, fatty acid methyl esters, fatty acid ethyl esters. The bio-renewable fats and oils include both edible and non-edible fats and oils. Examples of these bio-renewable fats and oils include, but are not limited to, algal oil, brown grease, canola oil, carinata oil, castor oil, coconut oil, colza oil, corn oil, cottonseed oil, fish oil, hempseed oil, jatropha oil, lard, linseed oil, milk fats, mustard oil, olive oil, palm oil, peanut oil, rapeseed oil, sewage sludge, soy oils, soybean oil, sunflower oil, tall oil, tallow, used cooking oil, yellow grease, and combinations thereof.

Another preferred class of renewable materials are liquids derived from biomass and waste liquefaction processes. Examples of such liquefaction processes include, but are not limited to, (hydro)pyrolysis, hydrothermal liquefaction, plastics liquefaction, and combinations thereof. Renewable materials derived from biomass and waste liquefaction processes may be used alone or in combination with bio-renewable fats and oils.

The renewable materials to be used as feedstock in the process of the present invention may contain impurities. Examples of such impurities include, but are not limited to, solids, iron, chloride, phosphorus, alkali metals, alkaline-earth metals, polyethylene and unsaponifiable compounds. If required, these impurities can be removed from the renewable feedstock before being introduced to the process of the present invention. Methods to remove these impurities are known to the person skilled in the art.

The process of the present invention is most particularly advantageous in the processing of feed streams comprising substantially 100% renewable feedstocks. However, in one embodiment of the present invention, renewable feedstock may be co-processed with petroleum-derived hydrocarbons. Petroleum-derived hydrocarbons include, without limitation, all fractions from petroleum crude oil, natural gas condensate, tar sands, shale oil, synthetic crude, and combinations thereof. The present invention is more particularly advantageous for a combined renewable and petroleum-derived feedstock comprising a renewable feed content of at least from 30 wt. %.

In a hydroprocessing process, renewable feedstock is reacted under hydroprocessing conditions sufficient to cause a reaction selected from hydrogenation, hydrotreating (including, without limitation, hydrodeoxygenation, hydrodenitrogenation, hydrodesulphurization, and hydrodemetallization), hydrocracking, selective cracking, hydroisomerization, and combinations thereof. The hydroprocessing process may be a single-stage or multi-stage and may be conducted in a single reactor or multiple reactors. The process of the present invention is a fixed-bed process, wherein a single reactor or multiple reactors may independently have a single catalyst bed or multiple catalyst beds. The process is operated in a co-current flow of liquid and gas.

The process according to the present disclosure is suitable for the production of fuels and/or fuel components and/or chemical feedstocks, which products include, for example, without limitation, naphtha boiling point range products, kerosene boiling point range products, diesel boiling point range products, LPG, detergent feedstocks, feedstocks for ethylene crackers, and combinations thereof.

The hydroprocessing of certain renewable materials is particularly highly exothermic, for example, without limitation, when the materials comprise high concentrations of unsaturated molecules and/or oxygenates, which results in large temperature increases over the catalyst beds.

A downward flow of renewable feedstock includes fresh feed, comprising material from renewable sources, liquid recycle, and, optionally, petroleum-derived feedstock in a coprocessing scenario, hydrogen, and, optionally, H₂S and/or a compound for generating H₂S in situ. Hydrogen may be combined with the renewable feedstock before it is introduced the hydroprocessing reactor, co-fed with the renewable feedstock or added to the hydroprocessing reactor independently of the renewable feedstock. Hydrogen may be fresh and/or recycled from another unit in the process and/or produced in a HMU (not shown). In another embodiment, the hydrogen may be produced in-situ in the reactor or process, for example, without limitation, by water electrolysis. The water electrolysis process may be powered by renewable energy (such as solar photovoltaic, wind or hydroelectric power) to generate green hydrogen, nuclear energy or by non-renewable power from other sources (grey hydrogen).

Operating conditions in the fixed-bed reactor include pressures in a range of from 1.0 MPa to 20 MPa, temperatures in a range of from 200 to 410° C. and liquid hourly space velocities in a range of from 0.3 m³/m³·h-5 m³/m³·h based on fresh feed. The ratio of hydrogen to feed supplied in the fixed-bed reactor is in a range of from 200 to 10,000 normal L (at standard conditions of 0° C. and 1 atm (0.101 MPa)) per kg of feed. Reference herein to feed is the total of fresh feedstock excluding any recycle that is added.

The catalyst may be the same or different throughout the hydroprocessing reactor(s) and/or throughout a single catalyst bed or multiple catalyst beds. Optionally, there is a mixture of catalysts, or different catalysts may be provided in two or more layers in a catalyst bed. In an embodiment of multiple catalyst beds, the catalyst may be same or different for each catalyst bed.

The hydrogenation components may be used in bulk metal form or the metals may be supported on a carrier. Suitable carriers include refractory oxides, molecular sieves, and combinations thereof. Examples of suitable refractory oxides include, without limitation, alumina, amorphous silica-alumina, titania, silica, and combinations thereof. Examples of suitable molecular sieves include, without limitation, zeolite Y, zeolite beta, ZSM-5, ZSM-12, ZSM-22, ZSM-23, ZSM-48, SAPO-11, SAPO-41, ferrierite, and combinations thereof.

The hydroprocessing catalyst may be any catalyst known in the art that is suitable for hydroprocessing. Catalyst metals are often in an oxide state when charged to a reactor and preferably activated by reducing or sulphiding the metal oxide. Preferably, the hydroprocessing catalyst comprises catalytically active metals of Group VIII and/or Group VIB, including, without limitation, Pd, Pt, Ni, Co, Mo, W, and combinations thereof. Hydroprocessing catalysts are generally more active in a sulphided form as compared to an oxide form of the catalyst. A sulphiding procedure is used to transform the catalyst from a calcined oxide state to an active sulphided state. Catalyst may be pre-sulphided or sulphided in situ. Because renewable feedstocks generally have a low sulphur content, a sulphiding agent is often added to the feed to maintain the catalyst in a sulphided form.

Preferably, the hydrotreating catalyst comprises sulphided catalytically active metals. Examples of suitable catalytically active metals include, without limitation, sulphided nickel, sulphided cobalt, sulphided molybdenum, sulphided tungsten, sulphided CoMo, sulphided NiMo, sulphided MoW, sulphided NiW, and combinations thereof. A catalyst bed/zone may have a mixture of two types of catalysts and/or successive beds/zones, including stacked beds, and may have the same or different catalysts and/or catalyst mixtures. In case of such sulphided hydrotreating catalyst, a sulphur source will typically be supplied to the catalyst to keep the catalyst in sulphided form during the hydroprocessing step.

The hydrotreating catalyst may be sulphided in-situ or ex-situ. In-situ sulphiding may be achieved by supplying a sulphur source, usually H₂S or an H₂S precursor (i.e., a compound that easily decomposes into H₂S such as, for example, dimethyl disulphide, di-tert-nonyl polysulphide or di-tert-butyl polysulphide) to the hydroprocessing catalyst during operation of the process. The sulphur source may be supplied with the feed, the hydrogen stream, or separately. An alternative suitable sulphur source is a sulphur-comprising hydrocarbon stream boiling in the diesel or kerosene boiling range that is co-fed with the feedstock. In addition, added sulphur compounds in feed facilitate the control of catalyst stability and may reduce hydrogen consumption.

In one embodiment of the present invention, the effluent from a catalyst bed is quenched before being contacted with a subsequent catalyst bed. After quenching, the downflow is directed through a distribution tray provided between two catalyst beds. Preferably, the quenched effluent is distributed through the plurality of nozzles to a second catalyst bed in a manner such that the area contacted by the downward flow from each of the plurality of nozzles overlaps the area contacted by the downward flow from at least another of the plurality of nozzles. In this way, a top surface of the second catalyst bed is uniformly wetted across the reactor cross section. Preferably, the type of distribution tray used for distributing the downward flow of feedstock to the first catalyst bed is the same type of tray as the distribution tray used between catalyst beds.

Effluent from a catalyst bed can be quenched using a method described in IPCOM000266022D (“Process for hydrotreatment of materials from renewable sources”, ip.com). For example, the effluent may be quenched using an internal heat exchanger below the preceding catalyst bed. In another embodiment, the effluent is quenched by passing at least a portion of the effluent through an external heat exchanger. The effluent may be first separated in a gas/liquid separator before being cooled in the external heat exchanger.

Quenching may be accomplished by adding a quench gas (e.g., cooled recycle gas) or a quench liquid (e.g., cooled catalyst bed effluent, cooled reactor effluent, cooled product stream) to effluent from a preceding catalyst bed before it passes through an interbed distribution tray. For example, the quench gas and/or quench liquid may be added via a quench mixing device. An example of a quench mixing device is an Ultra-Flat Quench System Internals, available from Shell Catalysts & Technologies. Such a quench mixing device provides a homogeneous quenched effluent that reduces radial temperature differences over the cross section of the reactor and catalyst bed. The temperature drop caused by the quenching results in a uniform temperature distribution of the effluent before it enters the next catalyst bed. This preferably means that after quenching, the difference between the highest and lowest temperature of the quenched effluent over the reactor cross section is at maximum 25% of the average temperature drop caused by the quenching. For the avoidance of doubt, any quench used between catalyst beds is not the same as recycling, as discussed above.

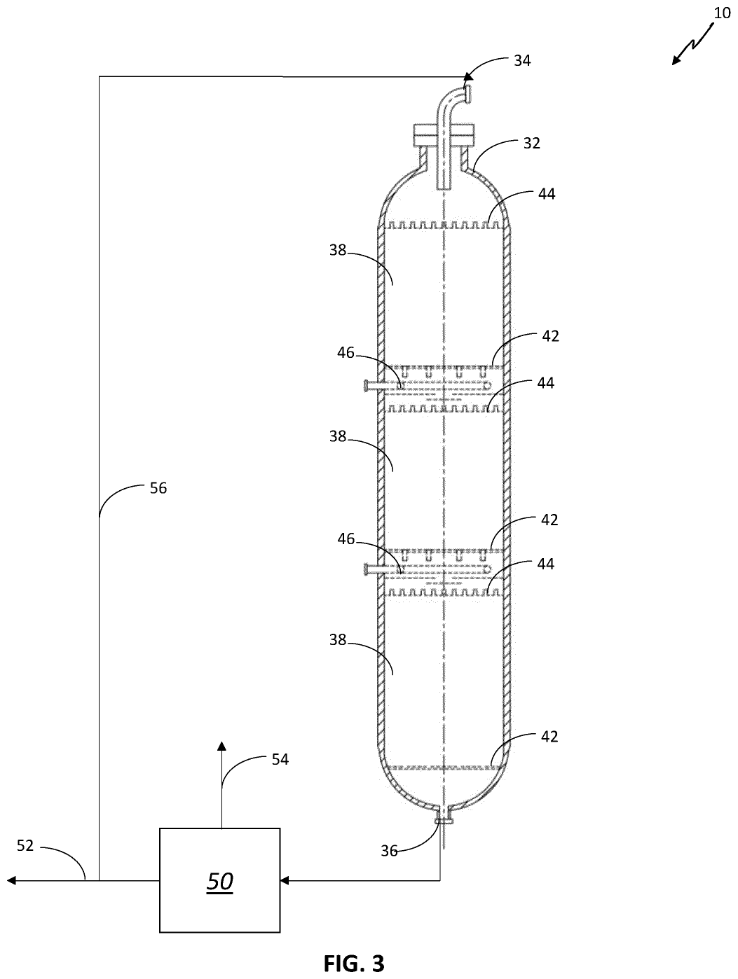

Referring now to FIG. 3, one embodiment of a fixed bed reactor 32 for use in the process of the present invention 10 has an inlet 34 and an outlet 36. As noted above, the fixed bed reactor 32 of the present invention may have a single catalyst bed or multiple catalyst beds. In the embodiment of FIG. 3, there are three catalyst beds 38, each placed on a catalyst support grid 42. A distribution tray 44 is placed above each catalyst bed 38. The distribution trays 44 have a plurality of nozzles.

Renewable feedstock is introduced, together with hydrogen, to the top portion of the fixed bed reactor 32 in a downward flow. The downward flow is directed to a distribution tray 44 above the first catalyst bed 38, where the downward flow is distributed through the plurality of nozzles to the top surface of the first catalyst bed 38. The distribution of gas and liquid in the downward flow is such that the top surface of the first catalyst bed 38 is uniformly wetted across the reactor cross-section.

The renewable feedstock is allowed to flow downwardly through the first catalyst bed 38. Under hydroprocessing conditions, contact with the catalyst and hydrogen causes a hydroprocessing reaction.

While the need for quenching between catalyst beds 38 may be reduced using the process of the present invention, FIG. 3 illustrates an embodiment having quench mixing devices 46. In this embodiment, the quench liquid and/or gas is provided externally through an outer wall of the fixed bed reactor 32.

The effluent from the first catalyst bed 38 is quenched and mixed in the quench mixing device 46 to provide a homogeneous fluid wherein the difference between the highest and lowest temperature of the quenched effluent over the reactor cross-section is less than 25% of the average temperature drop caused by the quenching.

The quenched effluent is then directed to an interbed distribution tray 44. The quenched effluent is distributed through a plurality of nozzles in a manner such that the top surface of the second catalyst bed is uniformly wetted across the reactor cross section. After passing through the last catalyst bed 38, the reactor effluent from outlet 36 is separated in a separation system 50 into a liquid product 52 and a gas stream 54. A portion of the liquid product 52 is directed as a recycle stream 56 to the renewable feedstock.

The separation system 50 has one or more separation units including, for example, without limitation, gas/liquid separators, including hot high- and low-pressure separators, intermediate high- and low-pressure separators, cold high- and low-pressure separators, strippers, integrated strippers and combinations thereof. Integrated strippers include strippers that are integrated with hot high- and low-pressure separators, intermediate high- and low-pressure separators, cold high- and low-pressure separators. It will be understood by those skilled in the art that high-pressure separators operate at a pressure that is close to the hydroprocessing section 14 pressure, suitably 0-10 bar (0-1 MPa) below the reactor outlet pressure, while a low-pressure separator is operated at a pressure that is lower than a preceding reactor in the hydroprocessing section 14 pressure or a preceding high-pressure separator, suitably 0-15 barg (0-1.5 MPaG). Similarly, it will be understood by those skilled in the art that hot means that the hot-separator is operated at a temperature that is close to a preceding reactor in the hydroprocessing section 14 temperature, suitably sufficiently above water dew point (e.g., >20° C., preferably >10° C., above the water dew point) and sufficiently greater than salt deposition temperatures (e.g., >20° C., preferably >10° C., above the salt deposition temperature), while intermediate- and cold-separators are at a reduced temperature relative to the preceding reactor in the hydroprocessing section 14. For example, a cold-separator is suitably at a temperature that can be achieved via an air cooler. An intermediate temperature will be understood to mean any temperature between the temperature of a hot- or cold-separator.

Hydroprocessed effluent from one or more reactor 32 may each be treated in a separate embodiment of the separation system 50. Effluents from different reactors/zones may be treated in all or some of the same separation units.

In a preferred embodiment of the present invention, the process comprises a hydrotreating reaction and an additional reaction selected from a hydroisomerization reaction, a selective hydrocracking reaction and/or a hydrodearomatization reaction. The hydrotreating reaction and the additional reaction(s) may be accomplished in a single stage or multiple stage process. One or more of the hydrotreating reaction and additional reaction(s) may be conducted step-wise and/or simultaneously by selecting the appropriate catalyst(s) and/or operating conditions.

The effluent from the hydrotreating reaction may contain significant amounts of n-paraffins in the C9-C24 range. It is preferable to improve the cold flow properties of the liquid product(s) from the process of the present invention by processing at least part of the effluent from the hydrotreating step in a subsequent hydroisomerization reaction. In the hydroisomerization reaction the stream comprising n-paraffins is contacted with a hydroisomerization catalyst under hydroisomerization conditions to at least isomerize part of the n-paraffins. Hydroisomerization processes and suitable hydroisomerization catalysts are known to the person skilled in the art.

It may also be desirable to selectively crack at least part of the hydrotreating effluent in a selective hydrocracking reaction. In the selective hydrocracking reaction, the stream comprising n-paraffins is contacted with a selective hydrocracking catalyst under hydrocracking conditions to at least crack part of the n-paraffins to molecules with a lower boiling range. Hydrocracking processes and suitable hydrocracking catalysts are known to the person skilled in the art. The selective hydrocracking reaction may be combined with the hydroisomerization reaction and/or the hydrotreating reaction.

The hydroisomerization reaction and/or selective hydrocracking reaction may follow the hydrotreating reaction without any separation step in between the steps. An example of such an hydroisomerization step without intermediate separation step is described in e.g., EP2121876.

In another embodiment, the effluent from the hydrotreating reaction is separated into a liquid phase and a gaseous phase. The liquid phase is sent to the additional reaction together with a hydrogen containing gas stream, not being the gaseous phase as obtained directly from the separation from the liquid phase. The liquid phase from hydrotreating reaction may be stripped from dissolved contaminants, such as e.g., CO, CO₂, H₂O, H₂S and NH₃. before being sent to the hydroisomerization step and/or selective hydrocracking step. The hydroisomerization step and/or hydrocracking step may be in co-current mode or in counter-current mode, preferably in co-current mode.

The effluent from the hydrotreating reaction may contain significant amounts of aromatics. It may be preferable to improve the properties of the liquid product(s) from the process of the present invention by processing at least part of the effluent from the hydrotreating reaction in a subsequent hydrodearomatization step. In the hydrodearomatization step, the stream comprising aromatics is contacted with a hydrodearomatization catalyst under hydrodearomatization conditions to at least saturate part of the aromatics. Hydrodearomatization processes and suitable hydrodearomatization catalysts are known to the person skilled in the art.

The hydrodearomatization step may follow the hydrotreating reaction without any separation step between the steps. Preferably, the effluent from the hydrotreating reaction is separated into a liquid phase and a gaseous phase. At least part of the liquid phase, optionally after first fractionating the liquid phase, is sent to the hydrodearomatization step together with a hydrogen containing gas stream, not being the gaseous phase as obtained directly from the separation from the liquid phase. The liquid phase from hydrotreating reaction may be stripped from dissolved contaminants, such as e.g., CO, CO₂, H₂O, H₂S and NH₃, before being sent to the hydrodearomatization step. The hydrodearomatization step may be in co-current mode or in counter-current mode, preferably in co-current mode.

In an embodiment where both hydrodearomatization and hydroisomerization and/or selective hydrocracking is desired, the hydrodearomatization step may precede the hydroisomerization step and/or selective hydrocracking step, but it may also follow the hydroisomerization step and/or selective hydrocracking step. Where the hydrodearomatization step follows the hydroisomerization step and/or selective hydrocracking step without separation between the hydrotreating step and the hydroisomerization step and/or selective hydrocracking step, it is advantageous and preferable to separate the effluent of the hydroisomerization step and/or selective hydrocracking step into a liquid phase and a gaseous phase. At least part of the liquid phase, optionally after first fractionating the liquid phase, is sent to the hydrodearomatization step together with a hydrogen containing gas stream, not being the gaseous phase as obtained directly from the separation from the liquid phase. The liquid phase from hydroisomerization step or selective hydrocracking step may be stripped from dissolved contaminants, such as e.g., CO, CO₂, H₂O, H₂S and NH₃, before being sent to the hydrodearomatization step.

The effluent from one or more hydroprocessing reactions may be sent to fractionation to produce a gasoil boiling point range fraction, a diesel boiling point range fraction, a kerosene boiling point range fraction, a naphtha boiling point range fraction, and combinations thereof, as desired.

### EXAMPLES

The following non-limiting examples of embodiments of the process of the present invention as claimed herein are provided for illustrative purposes only.

A lab-scale stacked bed reactor was loaded with 31.25 mL of a hydrodemetallization/hydrogenation catalyst layered on top of 93.75 mL of a hydrotreating catalyst. The hydrogenation catalyst had 2 wt % Ni and 8 wt % Mo on an alumina support. The hydrotreating catalyst had 4 wt % Ni and 15 wt % Mo on an alumina support.

The catalysts were mixed with inert silicon carbide particles having a maximum diameter of about 7% of the effective catalyst diameter of the respective catalyst in each bed. The purpose of mixing the inert particles in each bed was to simulate the effect of a distribution tray that would be used in a larger scale operation for uniformly wetting the top surface of the catalyst bed. Specifically, the hydrogenation catalyst was diluted in a ratio of 1:2 parts catalyst:inert particles, while the hydrotreating catalyst was diluted in a ratio of 1:1.5 parts catalyst:inert particles.

The temperature of each bed was independently controlled by means of an oven. The temperature of both catalyst beds was set at 280° C. A feedstock consisting of refined tallow spiked with 0.34 wt % SulfrZol® 54 as a hydrogen sulphide precursor was supplied to the top bed at a WHSV of 1.0 g fresh oil per mL catalyst per hour. A gas stream comprising 100% vol % hydrogen was supplied to the top bed at a gas-to-oil ratio of 875 NL/kg. The total pressure at the reactor outlet was 75 bar (gauge).

The degree of conversion of the tallow feedstock was determined by analyzing the product hydrocarbon liquid using pyrolysis to determine the amount of organic oxygen remaining in the hydrocarbon product, while the gaseous effluent was analyzed using gas chromatography to determine the propane, a primary reaction product, produced in the reaction. The product hydrocarbon liquid was also analyzed for evidence of undesirable side reactions, for example, for hydrocarbons having more than 28 carbon atoms, demonstrating undesirable dimerization.

The invention was demonstrated by operating the reactor without recycle and with a low recycle ratio of 1:1 liquid hydrocarbon effluent to feed. Kinetic modeling based on these results was conducted to simulate the results for recycle rate of 0.4 and 1.8. The results are shown in Table I.

TABLE I

| Recycle (% vol. of feed) | 0 | 40 | 100 | 180 |
|---|---|---|---|---|
| O content (wt. %) | 0.33 | 0.37 | 0.45 | 0.61 |
| Conversion (%) | 97 | 96.5 | 95.7 | 94.3 |
| C3 Yield (% wt. of feed) | 5.1 | 5.0 | 4.8 | 4.5 |

As noted above, conventional processes are operated at recycle ratios greater than 2:1 to improve catalytic conversion of the feedstock. Surprisingly, the hydrodeoxygenation conversion for no recycle and low recycle, was higher than expected. Moreover, operation at each recycle ratio in Table I did not result in a measurable production of dimerization product, as would have been expected in conventional processes having non-uniform wetting.

While the embodiments are described with reference to various implementations and exploitations, it will be understood that these embodiments are illustrative and that the scope of the inventive subject matter is not limited to them. Many variations, modifications, additions and improvements are possible. Various combinations of the techniques provided herein may be used.

1. A process for hydroprocessing a renewable feedstock comprising the steps of:
introducing the renewable feedstock and hydrogen in a downward flow into a top portion of the fixed-bed reactor;
distributing the downward flow to a top surface of a first catalyst bed in a manner such that the top surface is uniformly wetted across the reactor cross section;
allowing the renewable feedstock to flow downwardly through the first catalyst bed;
reacting the renewable feedstock in the catalyst bed under hydroprocessing conditions sufficient to cause a reaction selected from the group consisting of hydrogenation, hydrodeoxygenation, hydrodenitrogenation, hydrodesulphurization, hydrodemetallization, hydrocracking, hydroisomerization, and combinations thereof to produce a hydrocarbon effluent;
separating a hydrocarbon liquid stream from the hydrocarbon effluent; and
recycling the hydrocarbon liquid to the renewable feedstock in a ratio of 0.4:1 to 1.8:1, based on the volume of the renewable feedstock.

2. The process according to claim 1, wherein the top surface of the first catalyst bed is uniformly wetted when at least 90% of the top surface is contacted by the downflow at a liquid velocity having a distribution range between highest and lowest local liquid velocities of at most 10%.

3. The process of claim 1, further comprising the step of directing the downward flow to a distribution tray having a plurality of nozzles, and wherein the downward flow is distrusted through the plurality of nozzles to the top surface in a manner such that the area contacted by the downward flow from each of the plurality of nozzles overlaps the area contacted by the downward flow from at least another of the plurality of nozzles.

4. The process of claim 1, wherein the fixed bed reactor further comprises a second catalyst bed and an effluent from the first catalyst bed is quenched and subsequently directed to an interbed distribution tray.

5. The process of claim 4, wherein the interbed distribution tray comprises a plurality of nozzles for distributing the quenched effluent through the plurality of nozzles to a top surface of the second catalyst bed in a manner such that the area contacted by the downward flow from each of the plurality of nozzles overlaps the area contacted by the quenched effluent from at least another of the plurality of nozzles, thereby uniformly wetting a top surface of the second catalyst bed across the reactor cross section.

6. A process according to claim 1, wherein quenching the effluent from the first catalyst bed is provided by adding a quench selected from quench gas, quench liquid and combinations thereof to the effluent before it passes through the interbed distribution tray.

7. A process according to claim 1, wherein the effluent is quenched by passing at least a portion of the effluent through an internal heat exchanger.

8. A process according to claim 1, wherein the effluent is quenched by passing at least a portion of the effluent through an external heat exchanger, optionally with a gas/liquid separator between the reactor and the external heat exchanger.

9. A process according to claim 1, wherein the quench is directed to a quench mixing device to provide a homogeneous quenched effluent.

10. A process according to claim 1, wherein after quenching, the difference between the highest and lowest temperature of the quenched effluent over the reactor cross section is less than 25% of the average temperature drop caused by the quenching.

11. A process according to claim 1, wherein the renewable feedstock is selected from the group consisting of one or more bio-renewable fats and oils, liquid derived from a biomass liquefaction process, liquid derived from a waste liquefaction process, and combinations thereof
